(19) United States
(12) Patent Application Publication
(10) Pub. No.: US 2012/0276381 A1
(43) Pub. Date: Nov. 1, 2012

(54) SURFACE COATING SYSTEM AND METHOD OF USING SURFACE COATING SYSTEM

(75) Inventor: Christopher C. Cypcar, Racine, WI (US)

(73) Assignee: DIVERSEY, INC., Sturtevant, WI (US)

(21) Appl. No.: 13/512,078

(22) PCT Filed: Nov. 24, 2010
(86) PCT No.: PCT/US2010/058026

§ 371 Date: Jul. 12, 2012

Related U.S. Application Data
(60) Provisional application No. 61/264,465, filed on Nov. 25, 2009.

(51) Int. Cl. B32B 7/12; B32B 27/40; B32B 27/30; B05D 1/36

(52) U.S. Cl. 428/355 N; 427/407.1; 428/423.1; 428/500

(57) ABSTRACT

A coating system for a surface (such as a floor) including an adhesive layer composition including a dispersible adhesive that forms an adhesive layer upon application to a surface, and a maintenance layer composition comprising a dispersible polymer that forms a maintenance layer upon application to the adhesive layer. The dispersible adhesive may include at least one of a styrene-butadiene latex, an acrylic latex material, a polyurethane latex, a polyvinyl acetate emulsion, and a combination thereof. The maintenance layer may include at least one of a UV-cured polymer, a nylon, an epoxy, a polyacrylate, a polystyrene acrylate, a polyurethane, a polyurea, and a combination thereof. The adhesive layer and the maintenance layer may form a finished coating having a peel strength greater than about 50 gf/25 mm.

### CROSS-REFERENCE TO RELATED APPLICATIONS

This application claims priority under 35 U.S.C. §119(e) to U.S. Provisional Patent Application No. 61/264,465 filed on Nov. 25, 2009. The contents of this application are hereby incorporated by reference in their entirety.

### INTRODUCTION

Floor care programs today are primarily used to both protect and enhance the appearance of a floor substrate, such as vinyl, linoleum, wood, concrete, marble, terrazzo, ceramic, and the like. These flooring materials are prone to wear and deterioration with traffic, such as pedestrian or vehicular traffic. Sacrificial coatings are often used to protect flooring materials from physical wear, scratching, staining, and chemical damage. These coatings are part of a floor care program which can include many different types of products, but generally involve the use of a base and/or finish applied to the surface of a floor substrate. This finish is then maintained with the use of cleaners and tools, which can include various buffing or burnishing machines. Although these programs are very effective, they are considered a large expense to customers. Additionally, if the surface becomes worn or unsatisfactory over time, it is necessary to entirely remove the floor finish or sealer utilizing various chemical compositions, commonly known as strippers. Such chemical stripping is time-consuming and labor-intensive.

It has also been common to treat many flooring substrates with durable semi-permanent coatings, such as those utilizing urethanes, epoxy, or silane technologies. These coating systems suffer from their lack of chemical removability and repairability, and removal often consists of sanding, mechanical abrasion, or chemical stripping. These are significant limitations and often result in unsatisfactory results.

Polymer-based floor coatings are an example of finishes or coatings that are typically applied with a mop or other applicator as an aqueous emulsion or solvent solution that dries to a hard protective film. The removal of these coatings from floor surfaces has traditionally required the use of corrosive chemical solutions, typically mixtures of alkalis and volatile solvents. Accordingly, recent trends in protective floor coatings are to move away from these traditional finishes and move toward the more durable, highly cross-linked coatings, such as UV-cured urethanes, polyurethane dispersions, and epoxies. These coatings, while they have enhanced durability over more traditional floor finishes, suffer in that they, too, eventually have to be removed from the floor due to scratching, scuffs, etc. However, while more traditional floor finishes can be removed chemically, the highly cross-linked nature of these more durable films makes them difficult, if not impossible, to remove by any means other than physical abrasion.

Additionally, with regard to either chemical or a mechanical abrasive stripping, often times the underlying flooring substrate or surface is damaged, for instance in the case of wood flooring where utilization of chemicals and/or water damages the wood surface.

Significant difficulties and deficiencies exist in repair, remediation or removal of the sacrificial or durable, semi-permanent coatings or finishes. Thus, there is an ongoing search for a surface coating system which would enable a surface to be coated with a finish, which can be quickly and easily applied, yet is readily removable and/or repairable after damage or wear.

In summary, a considerable number of deficiencies exist in the art relating to coating systems or finishes for surfaces, such as floor surfaces and the like.

### SUMMARY

Among other things a coating system is provided. The coating system may comprise an adhesive layer composition comprising a dispersible adhesive. The adhesive layer composition may form an adhesive layer upon application to a surface. The coating system may also comprise a maintenance layer composition comprising a dispersible polymer that forms a maintenance layer after application to the adhesive layer. The dispersible adhesive may comprise at least one of a styrene-butadiene latex, an acrylic latex material, a polyurethane latex, a polyvinyl acetate emulsion, and a combination thereof.

In another aspect, a method of coating a surface is provided. The method may comprise applying an adhesive layer composition comprising a dispersible adhesive to the surface to form an adhesive layer. The method may also comprise applying a maintenance layer composition comprising a dispersible polymer to form a maintenance layer after application to the adhesive layer. The dispersible adhesive may comprise at least one of a styrene-butadiene latex, an acrylic latex material, a polyurethane latex, a polyvinyl acetate emulsion, and a combination thereof.

In another aspect, a protected surface is provided. The protected surface may comprise a floor, an adhesive, and a durable polymer coating. The adhesive may comprise at least one of styrene-butadiene latex, acrylic latex material, polyurethane latex, polyvinyl acetate emulsions, and a combination thereof.

In another aspect, a method of coating a surface is provided. The method may comprise applying an adhesive layer composition comprising a dispersible adhesive to the surface to form an adhesive layer. The method may also comprise applying a maintenance layer composition comprising a dispersible polymer to form a maintenance layer on the adhesive layer. The adhesive layer and the maintenance layer may form a finished coating. The finished coating may have a peel strength greater than about 50 gf/25mm.

In another aspect, a method of coating a surface is provided. The method may comprise applying an adhesive layer composition comprising a dispersible adhesive to the surface to form an adhesive layer. The method may also comprise applying a maintenance layer composition comprising a dispersible polymer to form a maintenance layer on the adhesive layer. The adhesive layer and the maintenance layer may form a finished coating. The finished coating may have a tensile strength that is greater than an adhesive strength of the dispersible adhesive.

Other aspects of the invention will become apparent by consideration of the detailed description and accompanying drawings.

### BRIEF DESCRIPTION OF THE DRAWINGS

FIG. 1 shows an embodiment of a coating system of the invention.

FIG. 1A shows another embodiment of a coating system of the invention.

FIG. 2 shows another embodiment of a coating system of the invention.

FIG. 3 shows another embodiment of a coating system of the invention.

FIG. 4 shows a use of an embodiment of a coating system of the invention.

FIG. 5 shows another embodiment of a coating system of the invention.

FIG. 6 shows another embodiment of a coating system of the invention.

FIG. 7 shows another embodiment of a coating system of the invention.

FIG. 8 shows a use of an embodiment of a coating system of the invention.

### DETAILED DESCRIPTION

The present disclosure is not limited in its disclosure to the specific details of construction, arrangement of components, or method steps set forth herein. The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

As used herein, the term “adhesive” refers to a substance capable of holding materials together by surface attachment.

The present invention has potential applications on any surface where protection, cleanliness, gloss, scuff resistance, or slip resistance is desirable. Such surfaces include floors, food preparation surfaces, walls, stalls, counters, bathroom fixtures, etc. The surfaces to be finished may be made from a large variety of materials including, but not limited to, engineered stone, engineered wood, vinyl, marble, terrazzo, ceramic, linoleum, wood, metal, plastic, rubber, concrete, stone, vinyl composition tiles (“VCT”) and glass.

The invention relates to a coating system comprising an adhesive layer composition comprising a dispersible adhesive that forms an adhesive layer upon application, and a maintenance layer composition comprising a maintenance layer film former or dispersible polymer that forms a maintenance layer upon application. A finished coating is formed after application of the maintenance layer composition to the adhesive layer. The coating system optionally includes a base layer composition and/or a transition layer composition. In addition, the coating system optionally includes a removal tool and/or instructions for use. The finished coating has a tensile strength that is greater than the peel strength of the finished coating. This allows the finished coating to be non-chemically removed from the surface with minimal to no damage to the surface.

The adhesive layer composition may comprise at least about 10 wt %, at least about 15 wt %, at least about 20 wt %, and at least about 25 wt % dispersible adhesive. The adhesive layer composition may comprise less than about 95 wt %, less than about 80 wt %, less than about 65 wt %, and less than about 50 wt % dispersible adhesive. This includes about 10 to about 95 wt %, about 15 to about 80 wt %, about 20 to about 65 wt %, and about 25 wt % to about 50 wt %.

The adhesive layer may comprise at least about 75 wt %, at least 80 wt %, and at least 85 wt % dispersible adhesive. The adhesive layer may comprise less than about 100 wt %, less than about 99 wt %, less than about 98 wt %, less than about 97 wt %, less than about 96 wt %, less than about 95 wt %, less than about 94 wt %, less than about 93 wt %, less than about 92 wt %, less than about 91 wt %, less than about 90 wt %, and less than about 85 wt % dispersible adhesive. This includes about 75 to about 100 wt %, about 85 to about 99 wt %, and about 90 wt % to about 98 wt %. The dispersible adhesive may comprise at least one of acrylate polymers, styrene-butadiene polymers, acrylic polymers, polyurethane polymers, polyvinyl acetate polymers, and combinations thereof.

The maintenance layer composition may comprise at least about 10 wt %, at least about 15 wt %, at least about 20 wt %, and at least about 25 wt % maintenance layer film former or dispersible polymer. The maintenance layer composition may comprise less than about 90 wt %, less than about 80 wt %, less than about 70 wt %, less than about 60 wt %, and less than about 50 wt % maintenance layer film former or dispersible polymer. This includes about 10 to about 90 wt %, about 15 to about 80 wt %, about 20 to about 70 wt %, and about 25 wt % to about 50 wt %.

The maintenance layer may comprise at least about 75 wt %, at least about 80 wt %, and at least about 85 wt % maintenance layer film former or dispersible polymer. The maintenance layer may comprise less than about 100 wt %, less than about 99 wt %, less than about 98 wt %, less than about 97 wt %, less than about 96 wt %, less than about 95 wt %, less than about 94 wt %, less than about 93 wt %, less than about 92 wt %, less than about 91 wt %, less than about 90 wt %, and less than about 85 wt % maintenance layer film former or dispersible polymer. This includes about 75 to about 100 wt %, about 85 to about 99 wt %, and about 90 wt % to about 98 wt %. The maintenance layer film former or dispersible polymer may comprise at least one of at least one of a UV-cured polymer, a nylon, an epoxy, a polyacrylate, a polystyrene acrylate, a polyurethane, a polyurea, and a combination thereof.

Dispersible adhesives and dispersible polymers have the characteristic that they are easily dispersed on, or applied to, a surface, i.e., with spraying, spreading, brushing, rolling, wiping, etc. Dispersible adhesives and polymers are typically liquids, however, they may take the form of aerosols. The dispersible adhesives and polymers typically comprise one or more polymers that are suspended in a carrier medium such as water, a propellant, or an organic solvent.

Other additives such as plasticizers, neutralizers, wetting agents, defoamers, coalescing agents, preservatives, dyes, pigments, fragrances, nanoparticles, cross-linking agents such as zinc ammonia carbonate, and others known to those skilled in the art can be added to the maintenance layer composition or the adhesive layer composition.

Suitable plasticizers include, but are not limited to, dibutyl phthalate, butyl benzyl phthalate, diisooctyl phthalate, diethylene glycol dibenzoate, triethylene glycol dibenzoate, dipropylene glycol dibenzoate, tributoxy ethylphosphate and many other plasticizers known to those skilled in the art. In some embodiments, the plasticizer is in the range of up to about 5 wt % or up to about 3 wt % or up to about 1 wt % of the peelable layer composition. In other embodiments, the plasticizer is present in at least about 0.1 wt % or at least about 0.5 wt %. This includes ranges of about 0.1 to about 5 wt % and about 0.5 to about 3 wt %. Some embodiments include plasticizer in the amount of about 0.5 wt %.

Neutralizers can be used to adjust the pH of the compositions. For example, ammonia, ammonium hydroxide, amines, hydroxides, silicates, phosphates and other additives known to those skilled in the art can be used to adjust the pH of the system if deemed necessary at a range of up to about 2 wt % or up to 1 wt % or up to about 0.5 wt % of the composition. In other embodiments, the neutralizer can be present in an amount of at least about 0.05 wt % or at least about 0.1 wt %. This includes ranges of about 0.05 to about 2 wt % and about 0.1 to about 1 wt %. Alternative embodiments can include about 0.1 wt % neutralizer.

Wetting agents such as ethoxylated non-ionic fluorochemicals, other fluorochemicals, alcohol ethoxylates, organo-silicones, or others known to those of skill in the art. These materials can be used up to about 10 wt %, up to about 5 wt %, or up to about 3 wt % of the composition. In other embodiments, the wetting agent can be present in an amount of at least about 0.01 wt %, at least about 0.03 wt %, or at least about 0.05 wt %, or at least about 1.0 wt %. This includes ranges of about 0.01 to about 10 wt %, about 0.03 to about 5 wt %, and about 0.05 to about 3 wt %. Some embodiments utilize about 1 wt % wetting agent. Still other embodiments include about 0.03 wt % wetting agents.

Defoamers include, but need not be limited to, polysiloxane, silicone or acetylene-based defoamers. The defoamer may be present in about 0 to about 2 wt % of the composition.

Coalescing agents such as glycol ethers including, but not limited to, diethylene glycol ethyl ether, ethylene glycol 2-ethylhexyl ether, and dipropylene glycol n-butyl ether, or other suitable solvents can be utilized. The coalescent agent can be present in the amounts described above with respect to the wetting agent.

Various preservatives, dyes, pigments, fragrances, nanoparticles, and other additives can also be included in some embodiments, such as the Robertet fragrances including Robertet 98M, nanoparticles, and other additives can also be included in some embodiments. Suitable preservatives include PROXEL GXL (1,2-benzisothiazolin-3-one Na-salt (20%)).

The balance of the maintenance layer composition and the adhesive layer compositions may be water.

The invention may provide at least one advantage identified below. Coating systems of the invention can be used to coat a surface with a removable, durable coating in a few minutes to a few hours, with removal of the durable coating taking seconds to minutes. The coating system can be applied with spraying, rolling, brushing, painting, mopping, or spreading, however other techniques will be known to those of skill in the art. Because the coating systems can use water-dispersed polymer compositions, the coating systems produce fewer organic volatiles compared to the prior art. Reduced organic volatiles benefit the environment as well as the health of the user, especially when the user would be otherwise exposed to the organic volatiles in a confined space. Additionally, because the used coatings are simply peeled away, there is no need for caustic stripping agents. Once removed, the used coatings may be recycled or sent to a landfill.

While a removal tool may be unnecessary with coating systems of the invention, coating systems may optionally include a removal tool, such as a razor blade, or a removal tool similar to that described in U.S. Application No. 61/023,351 filed Jan. 24, 2008 which is incorporated by reference herein in its entirety. One of ordinary skill in the art would be able to determine other suitable removal tools for use in the invention. In some embodiments, the removal tool may be a plastic ribbon that has been embedded in the coating.

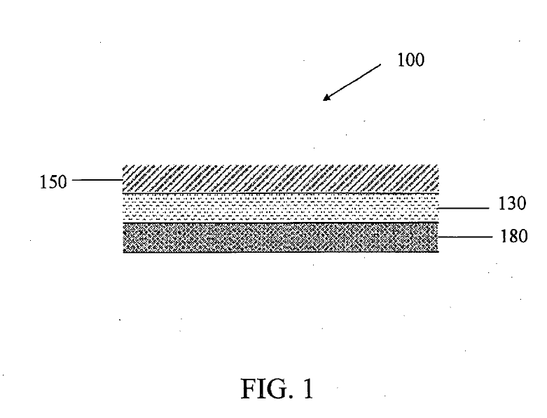

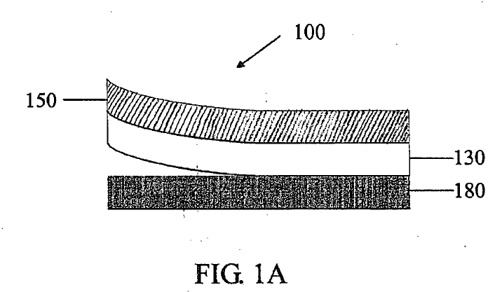

FIG. 1 shows finished coating 100 which may be prepared using the coating system and methods of the invention. Finished coating 100 comprises adhesive layer 130 and maintenance layer 150, which are both applied to surface 180, such as a floor.

The adhesive layer 130 comprises a dispersible adhesive, which forms on the surface 180 after an adhesive layer composition of the invention is applied to the surface 180. The adhesive layer 130 is less than about 1 cm thick, typically less than about 2 mm thick, more typically less than about 0.5 mm thick. In some embodiments, the adhesive layer 130 is at least about 0.001 mm thick, at least about 0.005 mm thick, at least about 0.01 mm thick, or at least about 0.015 mm thick. In some embodiments, the thickness of the adhesive layer 130 is about 1 cm to about 0.001 mm, about 2 mm to about 0.005 mm, or about 0.5 mm to about 0.01 mm. The adhesive layer 130 is applied at a rate of less than about 20 g/ft², typically less than about 8 g/ft², more typically less than about 4 g/ft².

The maintenance layer 150 is a durable coating, which forms on a surface 180 after a maintenance layer composition is applied to the surface 180. The maintenance layer 150 is less than about 3 cm thick, typically less than about 1 cm thick, more typically less than about 5 mm thick. In some embodiments, the maintenance layer 150 is at least about 0.01 mm thick, at least about 0.05 mm thick, at least about 0.1 mm thick, or at least about 0.15 mm thick. In some embodiments, the maintenance layer 150 thickness is about 3 cm to about 0.01 mm, about 1 mm to about 0.05 mm, or about 5 mm to about 0.1 mm. The maintenance layer 150 comprises at least one of UV-cured polymers, nylons, epoxies, polyacrylates, polystyrene acrylates, polyurethanes, polyureas, and combinations thereof. The maintenance layer 150 is applied at a rate of less than about 40 g/ft², typically less than about 20 g/ft², more typically less than about 10 g/ft².

Typically, an adhesive layer composition is applied to the surface 180, the adhesive layer composition is allowed to dry for some time to form the adhesive layer 130, and then the maintenance layer composition is applied to adhesive layer 130 which has formed on surface 180. Typically, the maintenance layer composition is allowed to dry for some time, during which the maintenance layer 150 forms on the adhesive layer 130, forming the finished coating 100. The finished coating 100 may have a tensile strength greater than a peel strength of the finished coating 100 from surface 180. The peelability of the adhesive layer 130 is illustrated in FIG. 1A, which shows the removal of adhesive layer 130 and maintenance layer 150 from the surface 180 as the finished coating 100. The adhesive layer composition is typically allowed to dry for at least about 1 minute, typically for at least about 10 minutes, more typically for at least about 60 minutes. The maintenance layer composition is typically allowed to dry for at least about 1 minute, typically for at least about 10 minutes, more typically for at least about 60 minutes. The finished coating 100 may have an elongation failure point of greater than about 10%, typically greater than about 25%, or more typically greater than about 50%. The elongation failure point may be 150%. In some embodiments, the elongation failure point of the finished coating 100 may be less than about 350%, or less than about 300%, or less than about 250%, or less than about 200%. In some embodiments, the elongation failure point of the finished coating 100 may be about 10% to about 350%, about 25% to about 300%, and about 50% to about 250%.

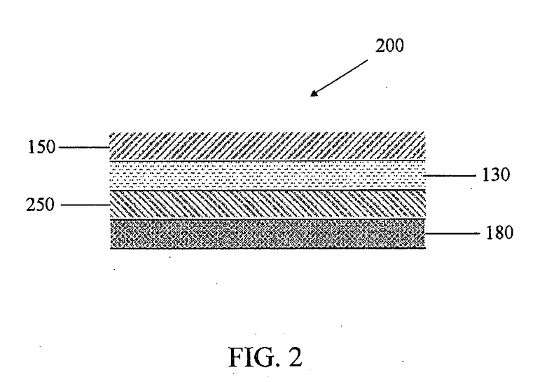

FIG. 2 shows an alternative finished coating 200 which may be prepared using the coating system and methods of the invention. The alternative finished coating 200 comprises the base coating 250, the adhesive layer 130, and the maintenance layer 150, which are both applied to surface 180, such as a floor. The adhesive layer 130 and the maintenance layer 150 in alternative finished coating 200 are substantially similar to the adhesive layer 130 and the maintenance layer 150 in the finished coating 100. (The adhesive layer 130 in the alternative finished coating 200 may comprise additional additives to impart better compatibility with base coating 250.) The base coating 250 is a continuous coating, which forms on the surface 180 after a base layer composition of the invention is applied to the surface 180. The base coating 250 comprises at least one of UV-cured polymers, nylons, epoxies, polyacrylates, polystyrene acrylates, polyurethanes, polyureas, and combinations thereof. The base coating 250 provides a continuous, level surface for the application of adhesive layer 130, and subsequent application of maintenance layer 150. Typically the base layer composition is applied to surface 180 and then allowed to dry to form base coating 250. The base layer composition is typically allowed to dry for at least about 1 minute, typically for at least about 10 minutes, more typically for at least about 60 minutes. The alternative finished coating 200 is suitable for use when surface 180 is not smooth, for example, a tile floor.

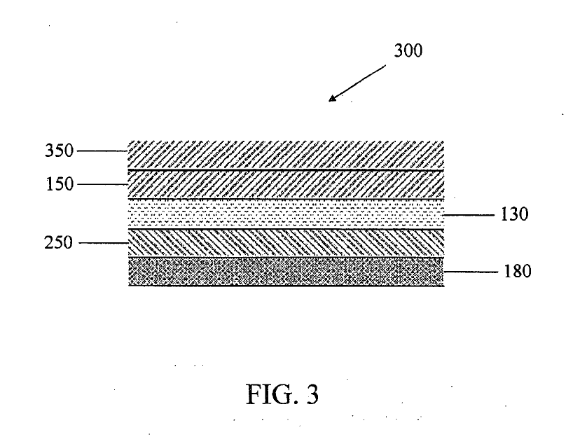

FIG. 3 shows an alternative finished coating 300 which may be prepared using the coating system and methods of the invention. The alternative finished coating 300 comprises a base coating 250, an adhesive layer 130, a maintenance layer 150, and a second maintenance layer 350, which are all applied to surface 180, such as a floor. The adhesive layer 130 and the maintenance layer 150 in the alternative finished coating 300 are substantially similar to the adhesive layer 130 and the maintenance layer 150 in the finished coating 100. The second maintenance layer 350 may be substantially similar to the maintenance layer 150, however it is possible to use different maintenance layer compositions according to the invention. While the base coating 250 is shown used with second maintenance layer 350 in the alternative finished coating 300, the second maintenance layer 350 can be used with a finished coating 100, comprising only an adhesive layer 130 and a maintenance layer 150. A second maintenance layer 350 may comprise any of the dispersible polymers suitable for use as maintenance layers of the invention.

Dispersible adhesives suitable for use in adhesive layer compositions of the invention include any dispersible adhesive comprising polymers which result in a pressure-sensitive adhesive which has an adhesive strength that allows a finished durable coating comprising adhesive layer 130 and maintenance layer 150 to be peeled away from surface 180. Adhesive materials include styrene-butadiene latex, acrylic latex material, polyurethane latex, polyvinyl acetate emulsions and combinations thereof. Pressure sensitive adhesives are a class of adhesives that form a bond simply by the application of light pressure to marry the adhesive. Acrylic latex containing carboxyl groups is one example of a common material in a pressure sensitive adhesive. Other examples of pressure sensitive adhesives include, but not limited to, NovaCryl PS-R 100, NovaCryl PS-R 200, NovaCryl PS-R 300, and NovaCryl 3797 from Omnova Solutions, Chester, S.C. and Acmal NX 2278, Acmol LA 449 S, and Acronol DS 3588 from BASF, Ludwigshafen, Germany.

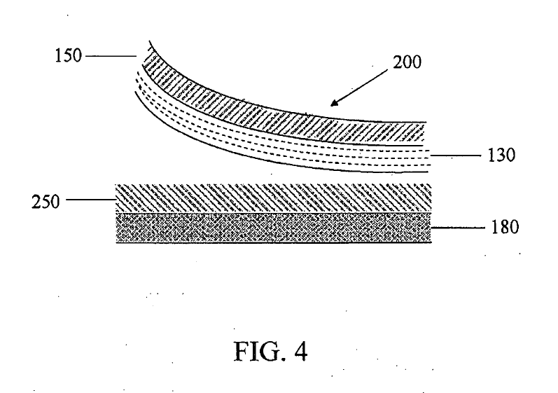

The peelability of adhesive layer 130 is illustrated in FIG. 4, which shows the removal of adhesive layer 130 and maintenance layer 150 from base coating 250 on surface 180 in the alternative finished coating 200. When finished coating 100 is used, adhesive layer 130 and maintenance layer 150 are directly removed from surface 180 (not shown). When used, base coating 250 is designed to remain adhered to surface 180, as shown in FIG. 4. Adhesive layer 130 and maintenance layer 150 are designed to remain adhered to one another, yet peel away from base coating 250 or surface 180 to enable stripping and refinishing of surface 180 with minimal to no damage to surface 180. Finished coating 100 comprising adhesive layer 130 and maintenance layer 150 may have a peel strength greater than about 50 gf/25 mm (gf=grams force), typically greater than about 100 gf/25 mm (gf=grams force), more typically greater than about 200 gf/25 mm (gf=grams force). In some embodiments, finished coating 100 may have a peel strength less than about 500 gf/25mm, less than about 400 gf/25 mm, or less than about 300 gf/25 mm. In some embodiments, finished coating 100 may have a peel strength of about 50 gf/25 mm to about 500 gf/25 mm, about 100 gf/25 mm to about 400 gf/25 mm, or about 200 gf/25 mm to about 300 gf/25 mm.

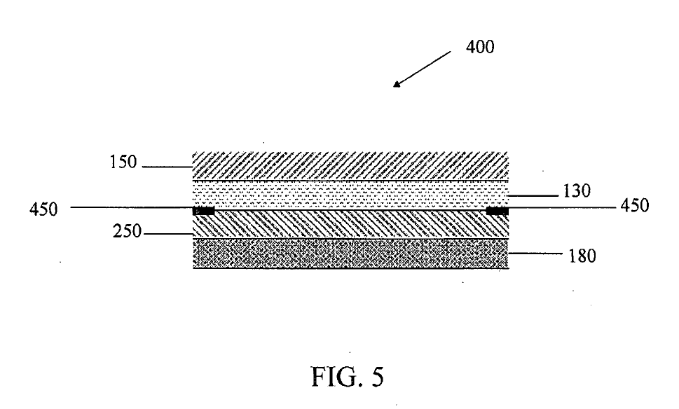

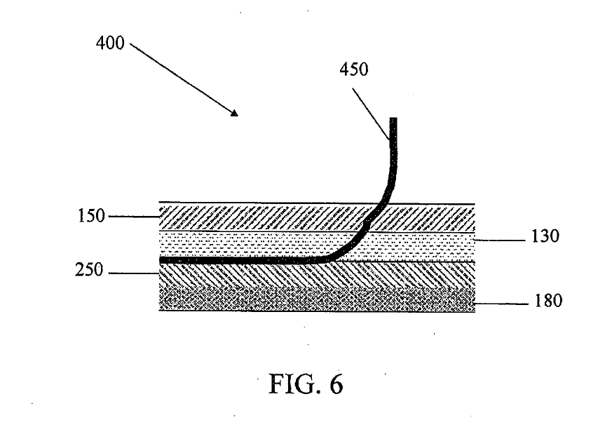

In some embodiments, a removal tool may be included in the coating, such as in finished coating with a starter mechanism 400, shown in FIG. 5. Starter mechanism 450 assists in initiating the peeling of adhesive layer 130 and maintenance layer 150 from base coating 250, or from surface 180 in a finished coating with starter mechanism (not shown). Starter mechanism 450 may be in the shape of a wire, ribbon or floss, and may be constructed from metal or plastic. Starter mechanism 450 may be opaque or colored to make starter mechanism 450 easily identifiable, or starter mechanism 450 may be clear to hide its presence in the finished coating. As shown in FIG. 6, starter mechanism 450 is simply pulled away from base coating 250 providing a clean edge (not shown) of adhesive layer 130 and maintenance layer 150, which is easy to pull away from base coating 250 and/or surface 180.

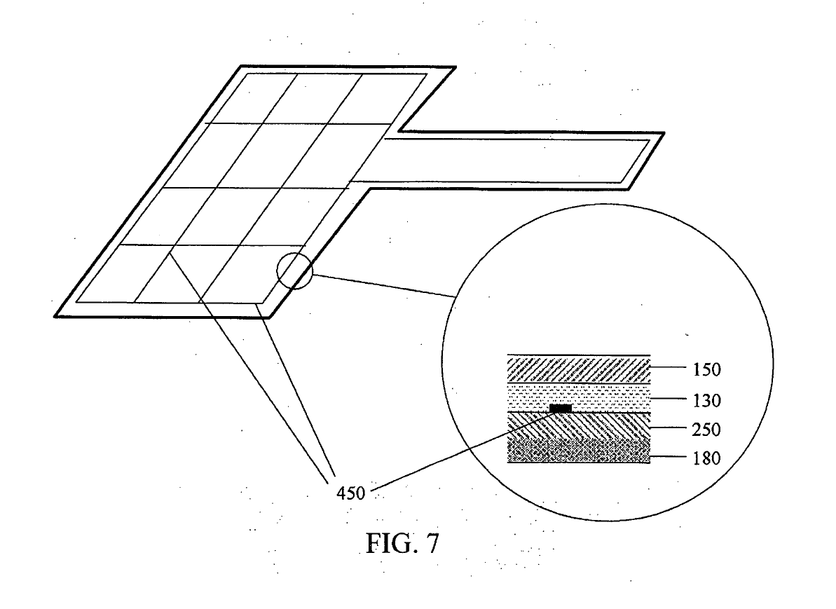

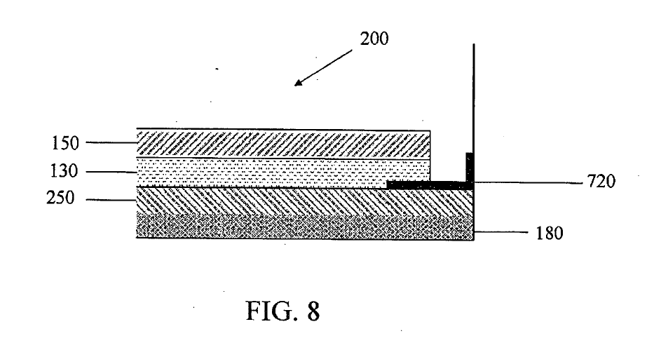

As shown in FIG. 7, a set of starter mechanisms 450 may be placed around the perimeter of surface 180 to provide a series of starting points for removing the coatings. Starter mechanisms 450 may also be placed across surface 180 to allow the finished coating to be pulled up in sheets of a manageable size. While starter mechanism 450 is shown in FIGS. 6 and 7 as being thinner than adhesive layer 130, starter mechanism 450 is typically at least as thick as adhesive layer 130. Additionally, starter mechanism 450 may be placed on surface 180 or base coating 250 prior to application of the adhesive layer composition, or starter mechanism 450 may be placed atop adhesive layer 130 prior to application of the maintenance layer composition. Regardless of the use of starter mechanism 450, scraping tool 720 may be used to assist a user in removing adhesive layer 130 and maintenance layer 150 from base coating 250 and/or surface 180 as shown in FIG. 8.

The starter mechanisms 450 can be strategically placed on a surface in order to facilitate removal of maintenance layer 150 and, where present, second maintenance layer 350. In some embodiments, starter mechanisms 450 are placed on opposite edges of the surface from which maintenance layer 150 is to be removed. For example, if the diagram shown in FIG. 7 represents a cross-section of a hallway, the starter mechanisms 450 could be placed on opposite sides of the hallway against the edges of adjacent walls. Thus, pulling up starter mechanisms 450 separates the layers from the walls to facilitate complete removal of the layers from the walls. In certain embodiments, starter mechanisms 450 are applied in a grid pattern, while in other embodiments starter mechanisms 450 are only applied in parallel side-by-side fashion. In still other embodiments, starter mechanisms 450 are applied in a pattern that facilitates removal and replacement of the layers in known or anticipated high-traffic areas of a floor, such as in the center of a hallway or in the vicinity of a doorway.

In some embodiments, starter mechanism 450 is relatively inconspicuous. For example, starter mechanism 450 can be clear and colorless, or starter mechanism 450 can have the same texture and/or color as surface 180 to which the surface coating system is applied. In other embodiments, starter mechanism 450 can be selected so as to be readily visible through the layers and, optionally, conventional floor finish coatings for quick identification. Examples starter mechanisms 450 can include tapes (e.g., polyester-based tapes), string, and plastic. Commercially available starter mechanisms can include fishing line, dental floss (comprising, e.g., thin nylon filaments or a ribbon made of a plastic such as polyethylene or Teflon), automobile pinstriping tape, and Linered Removable Acrylic Tape (#S922) available from Specialty Tapes of Franksville, Wis. In some embodiments, for example, starter mechanism 450 is an adhesive-backed tape that is about 6 mm wide and about 4.5 mil thick (1 mil is approximately 0.001 inch).

In some embodiments, starter mechanism 450 is applied to at least a portion of the base coating prior to the addition of the adhesive layer 130. However, it will be understood that starter mechanism 450 can be made from a variety of different materials, can have a variety of shapes and sizes, and can be applied in one or more places on base layer 180. Adhesive layer 130 can be applied to starter mechanism 450 and the base layer 180.

In some embodiments, one or more layers of finished coating 100 are applied to an installable flooring substrate (e.g. tiles or sheet materials) during the manufacture thereof. Thus, after the flooring substrate has been installed, its surface can be renewed by removing the topmost layer of finished coating 100. This can be repeated for as many layers as have been factory-applied to the substrate. In some embodiments, starter mechanisms 450 of each layer are offset, or staggered, from other starter mechanisms 450 of one or more nearby layers in order to prevent a possible buildup of layered materials that could distort the surface.

To remove maintenance layer 150 and second maintenance layer 350, or other layers thereon, starter mechanism 450 is pulled through the top layers to create a defined edge that can be used to peel maintenance layer 150 from the underlying base layer 180 as shown in FIG. 6. Starter mechanism 450 can be accessed by way of a starter strip, which can be exposed above the various layers, or by cutting through the top layers to reach an embedded starter strip.

In other embodiments, finished coating 100 is applied to surfaces other than floors, including, for example, other substantially horizontal surfaces, such as surgical tables, food preparation surfaces, desks, tables, as well as vertical surfaces, such as walls, windows, and the like, as well as irregular surfaces; such as food preparation equipment, vessels, tanks, parts, and the like, to name but a few possible uses.

In some embodiments, the maintenance layer composition is a water-borne composition. Maintenance layer 150 is the source of the durability and wear resistance of coating systems of the invention. Wear resistance includes resistance to physical wear, scratching, staining, and chemical damage, among other things. The maintenance layer composition should be compatible with the adhesive layer composition such that a defect-free durable coating results.

Additionally, additives that affect the optical properties of the maintenance layer can be added (“optical components”) in order to reduce the glossiness of maintenance layer 150 to produce a matte finish (“matte optical components”). A matte finish can improve the appearance of the floor by making defects less noticeable, and can give the floor a more uniform appearance. Suitable matte optical components include, but are not limited to, fumed silica, silica gels, polyethylene, and hollow glass microspheres. These are typically used in a range of 0.5 to 10 wt % of the maintenance layer composition. In other embodiments, in which a glossier finish is desired, the matte optical components are not included.

By incorporating certain wetting agents, plasticizers, and/or coalescents, maintenance layer 150 can be achieved with reduced or eliminated chances of incurring aesthetically unpleasant film defects such as “hazing”, “cracking”, “blooming”, “crazing”, and many other types of film defects commonly known to those of skill in the art. Without wishing to be limited by theory, it is believed that adding the surfactants, plasticizers, and/or coalescents enables better inter-coat adhesion and film-formation, which inherently reduces the likelihood of such defects.

Many different polymers-including, but not limited to, UV-cured polymers, nylons, epoxies, polyesters, polyvinyls, polyacrylates, polystyrene acrylates, polyurethanes, and polyureas are suitable for use in maintenance layer compositions of the invention. In some embodiments, the maintenance layer film former may have a glass transition temperature (“T_{g}”) of about −100° C. to about 20° C., suitably about −90° C. to about 30° C., or about −50° C. to about −20° C. For example, the T_{g} of the maintenance layer may be less than about −20° C., less than about −50° C., less than about −60° C., or less than about −80° C. The T_{g} may be greater than about 0° C., greater than about 20° C., greater than about 40° C., or greater than about 60° C. In those embodiments in which a blend of maintenance layer film formers is used, each film former may have a different T_{g}. In some embodiments of the invention, the maintenance layer film former may have more than one glass transition temperature (“T_{g}”). For these embodiments, the maintenance layer film former may have a first T_{g} from about −100° C. to about 20° C., and a second T_{g} from about −20° C. to about 120° C. Some embodiments may have a maintenance layer film former with a first T_{g} from about −50° C. to about −20° C., and a second T_{g} from about 40° C. to about 100° C. In some embodiments, the first T_{g} may be from about −40° C. to about −20° C., and the second T_{g} may be from about 70° C. to about 100° C.

It has been found that some floor finish compositions which are water-borne polyurethane-based compositions exhibit the necessary compatibility and durability properties required for the maintenance layer 150. In general, water-borne polyurethane-based compositions include polyurethane or polyurethane forming components including but not limited to, self-crosslinking polyurethanes or polyurethane copolymers.

Suitable maintenance layer compositions include commercially available floor finish materials such as Jonwood One Water Based Wood floor finish from Diversey Inc. of Sturtevant, Wis., Bona TRAFFIC and Bona MEGA waterborne finishes from Bona Kemi of Sweden. Suitable maintenance layer compositions also include commercially available film formers such as BAYHYDROL XP 2593/1 and BAYHYDROL XP 2557 and BAYHYDROL XP 2637 available from Bayer Material Science of Pittsburg, Pa. and TURBOSET 2025 Polyurethane Dispersion from Lubrizol Corp. of Wickliffe, Ohio, and NeoReZ 2180 Polyurethane Dispersion and NeoCryl 9045 Poylurethane Dispersion from NeoResins, The Netherlands. Suitable maintenance layer compositions may also include commercially available floor finish materials such as GEMSTAR LASER and GEMSTAR POLARIS and TAJ MAHAL and FIRST BASE available from Ecolab, Inc. of St. Paul, Minn., BETCO BEST and BETCO EXPRESS and BETCO FLOOR SEALER floor finish from Betco Corp. of Toledo, Ohio, CITATION and CASTLEGUARD floor finish available from Buckeye International of Maryland Heights, Mo., and IRONSTONE and PLAZA PLUS and PREMIA and HIGH NOON and FRESCOMAX and OVER & UNDER and JONSEAL from Diversey, Inc. of Sturtevant, Wis. These can be similar or identical to the composition of the base layer composition, but this is not required or necessary.

The maintenance layer composition can have a solids content of about 15% to about 50 wt % solids. This includes embodiments having a solids content of about 15 to about 25 wt %, which is suitable in some applications. The maintenance layer composition can be applied to provide about a 4 mil wet coating thickness. In some exemplary embodiments, the maintenance layer composition has a solids content of about 25 wt % and produces a hardened dried maintenance layer with a thickness of about 1.0 mil.

Multiple layers of the maintenance layer composition can be applied to completely cover the adhesive layer 130, resulting in a maintenance layer 150 with a total thickness of about 0.6 mil to about 4 mil in some embodiments. This total thickness may be at least about 0.1 mil, at least about 0.2 mil, at least about 0.5 mil, at least about 1 mil, at least about 1.5 mil, at least about 2 mil, at least about 2.5 mil, at least about 3.0 mil, and at least about 3.5 mil. The total thickness may be less than about 6.0 mil, less than about 5.5 mil, less than about 5.0 mil, less than about 4.5 mil, and less than about 4.0 mil. One to ten or more coats of the maintenance layer composition can be applied, in some embodiments. Some embodiments of the surface coating system can include four to six layers of maintenance layer 150. The maintenance layer(s) can also be scrubbed and recoated over time as needed, further increasing their thickness. More than one different type of formulation of the maintenance layer composition may be used in successive coats.

It may be desirable in some cases to repair only a portion of a damaged maintenance layer or surface coating system. To accomplish this, the damaged area can be removed using any suitable technique, such as cutting out using a razor blade or other tool suitable for cutting the layers, and peeling only the cut out section away creating an exposed surface. After removal, the adhesive layer composition can be re-applied to the exposed surface (i.e., the area where the section was removed) to form a repaired adhesive layer. After adhesive layer 130 dries, the maintenance layer composition can then be applied to obtain a repaired coating.

Suitable base layer compositions include, but are not limited to, UV-cured polymers, polyacrylates, polystyrene-acrylate, polyurethanes, epoxies, and polyureas. Other suitable compositions are known to those skilled in the art. The base layer composition may be the same as the maintenance layer composition, but this is not required or necessary. In a water-borne polyacrylate or polystyrene-acrylate based composition includes a polyacrylate or polystyrene component including but not limited to, styrene, methacrylic acid, butyl acrylate, and methylacrylate derived monomeric units. In other embodiments, base layer 250 can also include vinyl-acrylic compounds. In some embodiments, a blend of base layer compositions may be used.

Suitable base layer compositions may include commercially available floor finish materials such as GEMSTAR LASER and GEMSTAR POLARIS and TAJ MAHAL and FIRST BASE available from Ecolab, Inc. of St. Paul, Minn., BETCO BEST and BETCO EXPRESS and BETCO FLOOR SEALER floor finish from Betco Corp. of Toledo, Ohio, CITATION and CASTLEGUARD floor finish available from Buckeye International of Maryland Heights, Mo., and IRONSTONE and PLAZA PLUS and PREMIA and HIGH NOON and FRESCOMAX and OVER & UNDER and JONSEAL from Diversey, Inc. of Sturtevant, Wis.

While not wishing to be bound by a particular theory, it is theorized that base layer 250 may provide a surface that is physically and chemically normalized, which is believed to be important for the performance of the coating system. Physically normalized means a surface with nearly equal roughness, porosity, and/or surface morphology as that reached by mechanical and/or chemical methods. Chemically normalized means a surface with nearly equal distribution of chemical moieties such as hydroxyl groups, ester groups, hydrocarbon groups, fluorochemical groups, phosphate groups, organo-phosphate groups, metal and metal oxides and the like as that reached by mechanical and/or chemical methods. Suitably, the surface is substantially free of chemical moieties which would either dramatically increase (too much adhesion) or decrease (too little adhesion) adhesion of adhesive layer 130 and maintenance layer 150.

It should be understood that there may be one or more additional layers between the layers described above. In this manner, the layers may be applied directly or indirectly to one another.

### EXAMPLES

### Example 1

### Peelable Coatings with Acrylate Copolymer Adhesives and Polyurethane Dispersions

Four vinyl composite tiles (EXCELON brand, Armstrong Flooring, Lancaster, Pa.) were prepared with various combinations of ADHESIVE LAYER FORMULATIONS 1-3 and MAINTENANCE LAYER FORMULATION 1.

### Adhesive Layer Formulation 1

| | |
|---|---|
| 50 wt % | ACRONAL NX 2278 acrylate copolymer |
| | (BASF, Ludwigshafen, Germany) |
| 50 wt % | D.I. Water |

### Adhesive Layer Formulation 2

| | | |
|---|---|---|
| 50 | wt % | ACRONAL NX 2278—acrylate copolymer |
| 0.1 | wt % | BYK 025—defoamer (Byk Chemie, Wallingford, CT) |
| 0.1 | wt % | ZONYL FSJ—wetting agent (DuPont, Wilmington, DE) |
| 49.8 | wt % | D.I. Water |

### Adhesive Layer Formulation 3

| | | |
|---|---|---|
| 50 | wt % | ACRONAL DS 3588—acrylate copolymer |
| 0.1 | wt % | BYK 025—defoamer |
| 0.1 | wt % | ZONYL FSJ—wetting agent |
| 49.8 | wt % | D.I. Water |

### Maintenance Layer Formulation 1

| | | |
|---|---|---|
| 16.7 | wt % | D.I. Water |
| 4.0 | wt % | DOWANOL DPnB—solvent (Dow Chemical, |
| | | Midland, MI) |
| 0.2 | wt % | FOAMEX 822—defoamer (Tego Chemie, Hopewell, VA) |
| 0.90 | wt % | SOLSPERSE 40K—flow aid (Lubrizol Corp., |
| | | Wickliffe, OH) |
| 0.1 | wt % | BYK 307—flow and leveling aid (Byk Chemie) |
| 0.1 | wt % | BYK 347—flow and leveling aid (Byk Chemie) |
| 78.0 | wt % | TURBOSET 2025—polyurethane dispersion (Lubrizol) |

Tile 1—ADHESIVE LAYER FORMULATION 1 was applied to the the at a rate of 2 milliliters of solution per 1 sq ft using a foam paint brush. The adhesive layer was allowed to dry. Once the adhesive layer had dried, MAINTENANCE LAYER FORMULATION 1 was applied on top of the adhesive layer at a rate of 12 milliliters of solution per 1 sq ft using a foam paint brush. The maintenance layer was allowed to dry to a clear hard coating. Once the coating system had set, the coating system was evaluated for peelability (see TABLE 1).

Tile 2—ADHESIVE LAYER FORMULATION 2 was applied to the tile at a rate of 2 milliliters of solution per 1 sq ft using a foam paint brush. The adhesive layer was allowed to dry. Once the adhesive layer had dried, MAINTENANCE LAYER FORMULATION 1 was applied on top of the adhesive layer at a rate of 12 milliliters of solution per 1 sq ft using a foam paint brush. The maintenance layer was allowed to dry to a clear hard coating. Once the coating system had set, the coating system was evaluated for peelability (see TABLE 1).

Tile 3—ADHESIVE LAYER FORMULATION 3 was applied to the tile at a rate of 2 milliliters of solution per 1 sq ft using a foam paint brush. The adhesive layer was allowed to dry. Once the adhesive layer had dried, MAINTENANCE LAYER FORMULATION 1 was applied on top of the adhesive layer at a rate of 12 milliliters of solution per 1 sq ft using a foam paint brush. The maintenance layer was allowed to dry to a clear hard coating. Once the coating system had set, the coating system was evaluated for peelability (see TABLE 1).

Tile 4—MAINTENANCE LAYER FORMULATION 1 was applied to the tile at a rate of 12 milliliters of solution per 1 sq ft using a foam paint brush. The maintenance layer was allowed to dry to a clear hard coating.

The peeling characteristics of the finished coatings were assessed on a scale of 0-5, with 5 corresponding to excellent properties (easy to peel, little force required) and 0 corresponding to poor properties (doesn't peel, breaks). The results are shown in TABLE 1.

TABLE 1
Peeling characteristics of coatings.

| Tile | Peeling Rating | Surface Characterization |
|---|---|---|
| #1 | 5 | No adhesive residue |
| #2 | 5 | No adhesive residue |
| #3 | 3 | Adhesive residue |
| #4 | 0 | Tile damage |

### Example 2

### Peelable Coatings with Floor Sealant, Acrylate Copolymer Adhesives and Polyurethane Dispersions

A composite tile (EXCELON brand) was sealed with a water-based epoxy floor coating (JONSEAL 220, Diversey, Sturtevant, Wis.) using a wet applicator. The dried sealant makes a base coat for the remaining coatings.

ADHESIVE LAYER FORMULATION 2 was applied to the sealed tile at a rate of 2 milliliters of solution per 1 sq ft using a foam paint brush. The adhesive layer was allowed to dry. Once the adhesive layer had dried, MAINTENANCE LAYER FORMULATION 1 was applied on top of the adhesive layer at a rate of 12 milliliters of solution per 1 sq ft using a foam paint brush. The maintenance layer was allowed to dry to a clear hard coating. The final coating had an estimated dry weight of 1 gram/ft² of adhesive, and 4.56 gram/ ft² of maintenance coating.

Once the coating system had set, the coating system was evaluated for peelability was measured using ASTM D 6862-03—“Standard Test Method for 90 Degree Peel Resistance of Adhesives”. Using a Table Top Electromechanical Single Column Testing System (Model 3345, Instron Corp., Norwood, Mass.) a 1 inch-wide sample of the finished coating was evaluated for peel resistance at 1000 mm/min. Four total measurements were taken at 10 ° C. and 80% relative humidity, and the runs averaged. The average peel strength was 246.2 gf/25mm (gf=grams force), when the adhesive composition was applied at approximately 1 grams/ft sq dry weight and the maintenance layer composition was applied at approximately 4.56 grams/ft sq dry weight.

1. A coating system comprising:
a) an adhesive layer composition comprising a dispersible adhesive, the adhesive layer composition forming an adhesive layer upon application to a surface; and
b) a maintenance layer composition comprising a dispersible polymer, the maintenance layer composition forming a maintenance layer after application to the adhesive layer,
wherein the dispersible adhesive comprises at least one of a styrene-butadiene latex, an acrylic latex material, a polyurethane latex, a polyvinyl acetate emulsion, and a combination thereof, and
wherein the adhesive layer and the maintenance layer form a finished peelable coating, the finished peelable coating having a tensile strength that is greater than an adhesive strength of the dispersible adhesive.

2. The coating system of claim 1, wherein the dispersible adhesive comprises an acrylate copolymer.

3. The coating system of claim 1, wherein the dispersible adhesive forms a pressure-sensitive adhesive.

4. The coating system of claim 1, wherein the maintenance layer composition comprises at least one of a UV-cured polymer, a nylon, an epoxy, a polyacrylate, a polystyrene acrylate, a polyurethane, a polyurea, and a combination thereof.

5. The coating system of claim 1, wherein the maintenance layer composition comprises a polyurethane.

6. The coating system of claim 1, wherein the adhesive layer composition or the maintenance layer composition further comprises at least one additive selected from plasticizers, neutralizers, wetting agents, matting agents, defoamers, coalescing agents, preservatives, dyes, pigments, fragrances, nanoparticles, optical components, and embedded particles.

7. The coating system of claim 1, further comprising
c) a base layer composition comprising a dispersible polymer, the base layer composition forming a continuous coating after application to a surface.

8. The coating system of claim 1, wherein the adhesive layer and the maintenance layer form a finished coating, the finished coating having a tensile strength greater than a peel strength of the finished coating.

9. The coating system of claim 1, further comprising a removal tool.

10. A method of coating a surface, the method comprising:
a) applying an adhesive layer composition comprising a dispersible adhesive to the surface to form an adhesive layer; and
b) applying a maintenance layer composition comprising a dispersible polymer to form a maintenance layer after application to the adhesive layer,
wherein the dispersible adhesive comprises at least one of a styrene-butadiene latex, an acrylic latex material, a polyurethane latex, a polyvinyl acetate emulsion, and a combination thereof, and
wherein the adhesive layer and the maintenance layer form a finished coating, the finished coating having a peel strength greater than about 50 gf/25 mm.

11. The method of claim 10, wherein the dispersible adhesive comprises an acrylate copolymer.

12. The method of claim 10, wherein the dispersible adhesive forms a pressure-sensitive adhesive upon application to the surface.

13. The method of claim 10, wherein the maintenance layer composition comprises at least one of a UV-cured polymer, a nylon, an epoxy, a polyacrylate, a polystyrene acrylate, a polyurethane, a polyurea, and combination thereof.

14. The method of claim 10, wherein the maintenance layer composition comprises a polyurethane.

15. The method of claim 10, wherein the adhesive layer composition or the maintenance layer composition further comprises at least one additive selected from plasticizers, neutralizers, wetting agents, matting agents, defoamers, coalescing agents, preservatives, dyes, pigments, fragrances, nanoparticles, optical components, and embedded particles.

16. The method of claim 10, further comprising
c) a base layer composition comprising a dispersible polymer, the base layer composition forming a continuous coating after application to a surface.

17. The method of claim 10, wherein the adhesive layer and the maintenance layer form a finished coating, the finished coating having a tensile strength greater than a peel strength of the finished coating.

18. The method of claim 10, further comprising a removal tool.

19. The method of claim 18, wherein the removal tool is a plastic ribbon.

20. The method of claim 10, wherein the surface is a floor.

21. A protected surface comprising:
a) a floor;
b) an adhesive; and
c) a durable polymer coating,
wherein the adhesive comprises at least one of styrene-butadiene latex, acrylic latex material, polyurethane latex, polyvinyl acetate emulsions, and a combination thereof, and
wherein the adhesive layer and the maintenance layer form a finished peelable coating, the finished peelable coating having a tensile strength that is greater than an adhesive strength of the adhesive.

22. A method of coating a surface, comprising:
a) applying an adhesive layer composition comprising a dispersible adhesive to the surface to form an adhesive layer; and
b) applying a maintenance layer composition comprising a dispersible polymer to form a maintenance layer on the adhesive layer,
wherein the adhesive layer and the maintenance layer form a finished coating, the finished coating having a peel strength greater than about 50 gf/25 mm.

23. The method of claim 22, wherein the peel strength is greater than about 100 gf/25 mm.

24. The method of claim 22, wherein the peel strength is greater than about 200 gf/25 mm.

25. The method of claim 22, wherein the dispersible adhesive comprises at least one of an acrylate polymer, a styrene-butadiene polymer, an acrylic polymer, a polyurethane polymer, a polyvinyl acetate polymer, and a combination thereof.

26. The method of claim 22, wherein the dispersible adhesive comprises an acrylate copolymer.

27. The method of claim 22, wherein the maintenance layer composition comprises at feast one of a UV-cured polymer, a nylon, an epoxy, a polyacrylate, a polystyrene acrylate, a polyurethane, a polyurea, and combination thereof.

28. The method of claim 22, wherein the maintenance layer composition comprises a polyurethane.

29. The method of claim 22, wherein the surface is a floor.

30. The method of claim 22, wherein the finished coating has an elongation failure point, and the elongation failure point is about 50% to about 250%.

31. A method of coating a surface, the method comprising:
a) applying an adhesive layer composition comprising a dispersible adhesive to the surface to form an adhesive layer; and
b) applying a maintenance layer composition comprising a dispersible polymer to form a maintenance layer on the adhesive layer,
wherein the adhesive layer and the maintenance layer form a finished peelable coating, the finished peelable coating having a tensile strength that is greater than an adhesive strength of the dispersible adhesive.

32. The method of claim 31, wherein the dispersible adhesive comprises at least one of an acrylate polymer, a styrene-butadiene polymer, an acrylic polymer, a polyurethane polymer, a polyvinyl acetate polymer, and a combination thereof.

33. The method of claim 31, wherein the dispersible adhesive comprises an acrylate copolymer.

34. The method of claim 31, wherein the maintenance layer composition comprises at least one of a UV-cured polymer, a nylon, an epoxy, a polyacrylate, a polystyrene acrylate, a polyurethane, a polyurea, and combination thereof.

35. The method of claim 31, wherein the maintenance layer composition comprises a polyurethane.

36. The method of claim 30, wherein the elongation failure point of the finished coating is about 50% to about 250%.

37. The method of claim 31, wherein the surface is a floor.
